(19) United States
(12) Patent Application Publication
(10) Pub. No.: US 2008/0184531 A1
(43) Pub. Date: Aug. 7, 2008

(54) Hinge with adapted rotation friction

(76) Inventor: Po-Tsun Chao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,184

(22) Filed: Jul. 23, 2007

(30) Foreign Application Priority Data
Feb. 6, 2007 (TW) 96104235

(51) Int. Cl. E05C 17/64

(52) U.S. Cl. 16/342

(57) ABSTRACT

A hinge with adapted rotation friction includes a bracket, at least one cylinder, a pintle, and a pin. The bracket includes a plate-like structure extending along a horizontal datum plane and having a first edge and an opposite second edge. The first edge forms the cylinder of the bracket. The pintle includes a stem and an end plate. The stem has a free end, a mounting end mounted to the end plate, and at least one slit extending from the free end toward the mounting end. When the stem is inserted into the cylinder with the free end thereof, the pin is inserted into the slit of the stem to have the stem radially expanded to an increased outside diameter and thus making an outside circumference of the stem inducing a predetermined rotation friction with an inside surface of the cylinder of the bracket.

### FIELD OF THE INVENTION

The present invention relates to a hinge, and in particular to a hinge having an adapted rotation friction which is induced by inserting a pin into a slit that is defined in a pintle of the hinge.

### BACKGROUND OF THE INVENTION

Hinges have been widely used in various electronic devices to couple two separate components together to allow for relative rotation therebetween. An example application of the hinge is coupling of a liquid crystal display to for example a notebook computer, a mobile phone, a personal digital assistant (PDA), a satellite-based global positioning system (GPS), and inspection equipments, to allow a user to flip up and closed down the display device with respect to an enclosure of the electronic device.

A conventional hinge comprises a bracket having an edge forming a cylindrical structure to receive a stem of a rotation shaft or pintle therein. When the stem of the rotation shaft is operated and rotated, a rotation friction induced between an inside surface of the cylinder and an outside circumference of the stem provides an operation torque for a subject device.

To provide similar torque in both opening and closing the subject device to which the hinge is applied, the conventional hinge comprises forward-surrounding cylinder section and a reversed-surrounding cylinder section both mounted to the edge of the bracket to form a dual-surrounding cylinder configuration.

A variety of designs for the hinges are known. An example of the prior art references includes U.S. Pat. No. 6,671,929, which discloses a hinge structure for a notebook computer, comprising a pintle and two barrels. The pintle is arranged at centers of the barrels and a sleeve encloses a middle section of the pintle. The barrels have extended sections to be mounted to a notebook computer. Further, U.S. Pat. No. 6,321,416 discloses another hinge for a notebook computer, comprising a leaf, an elastic receiver, and a pintle. The leaf is connected to a notebook computer. The elastic receiver comprises cylinder and a slit or gap is defined in the cylinder and extending axially. The cylinder also forms at least one slot for receiving lubricant. The pintle comprises a plurality of circumferential grooves to effect lubrication to the hinge by the lubricant flowing in the grooves. Further, U.S. Pat. No. 5,632,066 also discloses a hinge for a portable computer comprising two horizontal walls, at least one cylinder, and a pintle. The horizontal walls are connected to a body of a computer. The cylinder is connected to ends of the adjacent horizontal walls. The pintle forms at least one lubricant channel. Further, U.S. Pat. No. 5,894,635 discloses a hinge comprising a hollow cylinder and a pintle. The hollow cylinder is a hollow member extending in axial direction. The pintle forms a central slot and a plurality of circumferential grooves.

A lot of know hinges are currently available in the market, but all these known hinge have certain drawbacks. Further, most of the known hinges consist of a cylinder and a pintle or a shaft. The cylinder is often mechanically tough in resisting deformation. Thus, conventionally, the pintle is coupled to the cylinder by forcibly fitting an end of the pintle into the cylinder, usually with the aid of properly arranged jigs, after the pintle is put in correct alignment with the cylinder. Such an assembling process is time-consuming and offers only very poor passing rate of the final products for damages are easy to occur in both the cylinder and the pintle in case they are not properly aligned or they are subject to incorrect assembling steps. This often leads to complete waste of the whole hinge.

In addition to the damages caused by improper assembling operation, the conventional hinge is often subject to failure or breaking due to long term operation or incorrect operation. The hinge has to be completely replaced once this happens. This increases the costs of maintenance and repairing.

Thus, it is desired to have a hinge that overcomes the above drawbacks of the conventional hinge devices.

### SUMMARY OF THE INVENTION

Thus, an objective of the present invention is to provide a pintle of a hinge, wherein the pintle has a stem in which at least one slit is formed for purposes of adjusting an overall outside diameter of the pintle so as to ease the operation of insertion of the pintle stem.

Another objective of the present invention is to provide a hinge pintle structure featuring adapted rotation friction, wherein when the pintle is inserted into a cylinder formed on a bracket, a pin is further inserted into the slit of the pintle to expand the pintle and to provide a predetermined rotation friction.

A further objective of the present invention is to provide a hinge pintle structure that is easy to assemble, wherein the pintle is first inserted into a cylinder formed on a bracket and then a pin is inserted into the pintle.

According to the present invention, a solution to realize the above discussed objectives resides in that a hinge comprises a pintle having a stem in which at least one slit is defined. When the stem of the pintle is inserted into a cylinder formed on a bracket, a pin is inserted into the slit to expand the pintle in a radial direction to an increased radial direction so that a predetermined rotation friction is induced between an outer circumference of the pintle stem and an inside surface of the bracket cylinder.

In a preferred embodiment of the present invention, the stem of the pintle further defines a central bore, whereby when the pin is inserted into the pintle stem, contact area is increased and a proper amount of rotation friction force can be induced between the outer circumference of the pintle stem and the inside surface of the cylinder when the hinge of the present invention is operated and rotated, thereby ensuring a desired torque applied to the hinge.

Due to the slits defined in the stem of the pintle, the present invention does not need to use force fitting that is conventionally used to combine a pintle to a cylinder of a bracket. Thus, the assembling process is simplified. Further, the non-adjustable nature of the conventional hinge is overcome so that the tough mechanical structure does not affect the convenience of assembling hinges. In addition, since the hinge is formed by individual components, replacement of any failure or broken parts can be easily carried out without the need of replacing the whole device. To conclude, the structure provided by the present invention allows the pintle to easily insert into the bracket cylinder with a simple operation so that the product passing rate is enhanced.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a hinge constructed in accordance with a first embodiment of the present invention;

FIG. 2 is a perspective view of the hinge of the first embodiment of the present invention in an assembled form;

FIG. 3 is a cross-sectional view taken along line 3-3 of FIG. 2;

FIG. 4 is a cross-sectional view taken along line 4-4 of FIG. 2;

FIG. 5 shows an application of the hinge in accordance with the present invention in a notebook computer;

FIG. 6 is an exploded view of a hinge constructed in accordance with a second embodiment of the present invention;

FIG. 7 is an exploded view of a hinge constructed in accordance with a third embodiment of the present invention;

FIG. 8 is a perspective view of the hinge of the third embodiment of the present invention in an assembled form; and

FIG. 9 is a cross-sectional view taken along line 9-9 of FIG. 8.

### DETAILED DESCRIPTION OF THE PREFERRED EMBODIMENTS

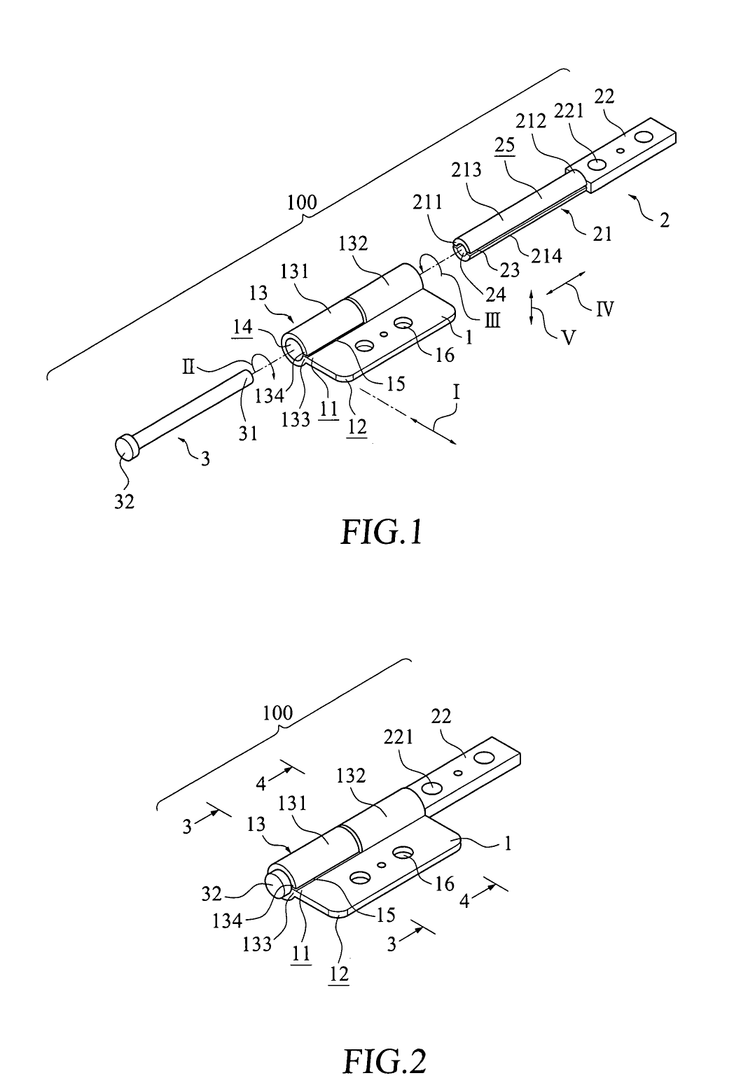

With reference to the drawings and in particular to FIGS. 1 and 2, wherein FIG. 1 illustrates an exploded view of a hinge constructed in accordance with a first embodiment of the present invention and FIG. 2 illustrates a perspective view of the hinge of the present invention in an assembled form, the hinge of the present invention, generally designated at 100, comprises a bracket 1, a pintle 2, and a pin 3. The bracket 1 comprises a plate-like structure extending along a horizontal datum plane 1 and having first edge 11 and an opposite second edge 12. The first edge 11 forms a barrel or cylinder 13.

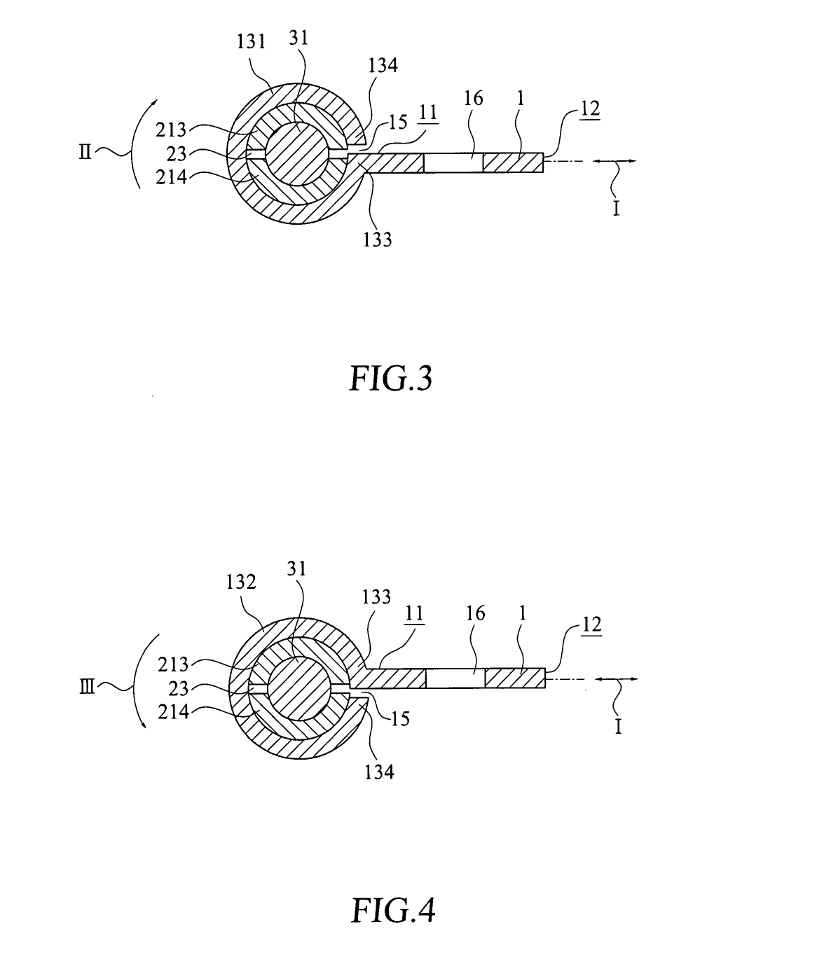

Also referring to FIG. 3, which shows a cross-sectional view taken along line 3-3 of FIG. 2, the cylinder 13 consists of a first-direction cylindrical section 131 extending in a first angular direction, and a second-direction cylindrical section 132 closely adjacent to the first-direction cylindrical section 131 and extending in an opposite second angular direction. The first-direction cylindrical section 131 has a root end 133 and a non-fixed end 134. The root end 133 is mounted to the first edge 11 of the bracket 1, while the non-fixed end 134 is extended from the first edge 11 in a circular path along angular direction II, such as clockwise direction, to get away from the root end 133. Thus, the cylinder 13 is formed as a C-shaped ring-like cross-sectioned configuration and the root end 133 and the non-fixed end 134 of the first-direction cylindrical section 131 form a gap 15 therebetween.

Also referring to FIG. 4, which shows a cross-sectional view taken along line 4-4 of FIG. 2, similar to the first-direction cylindrical section 131, the second-direction cylindrical section 132 has a root end 133 and a non-fixed end 134. The root end 133 is mounted to the first edge 11 of the bracket 1, while the non-fixed end 134 is extended from the first edge 1 in a circular path along angular direction III, such as counterclockwise direction, to get away from the root end 133. Thus, the cylinder 13 is formed as a C-shaped ring-like cross-sectioned configuration and the root end 133 and the non-fixed end 134 of the second-direction cylindrical section 132 form a gap 15 therebetween.

The pintle 2 comprises a stem 21 and an end plate 22. The stem 21 has a free end 211 and a mounting end 212 mounted to the end plate 22. The stem 21 is divided into an upper portion 213 and a lower portion 214 by a slit 23 that extends in an axial direction IV from the free end 211 to the mounting end 212. Preferably, the stem 21 forms a central bore 24 that extends from the free end 211 to the mounting end 212 and communicates the slit 23. Thus, the stem 21 features resiliency to adapt to deformation of outward expansion or inward contraction in radial direction V.

The stem 21 of the pintle 2 is inserted into the cylinder 13 with the free end 211 thereof. The slit 23 of the stem 21 allows adaptive adjustment of outside diameter of stem 21 so that the stem 21 can be easily inserted into the cylinder 13. The pin 3 is then fit into the central bore 24 of the stem 21 to outward expand the stem 21 in the radial direction V and thus providing an increased radial dimension of the stem 21. Thus, an outer circumference 25 of the stem 21 induces a predetermined rotation friction with an inside surface 14 of the cylinder 13 to apply a desired torque to the hinge 100.

The pin 3 has an insertion end 31 and a distal end 32. The distal end 32 of the pin 3 is expanded for abutting against an end of the cylinder 13 when the pin 3 is being inserted into the central bore 24 of the stem 21 and also functioning to prevent the cylinder 13 to separate in the axial direction IV.

The bracket 1 forms a plurality of fastening holes 16 for receiving conventional fasteners (not shown) therethrough to secure the hinge 100 to for example an enclosure of a notebook computer. An end of the stem 21 of the pintle 2 is mounted to an end plate 22, which forms a plurality of fastening holes 221 for receiving conventional fasteners (not shown) therethrough to secure the pintle 2 to for example a liquid crystal display of the notebook computer.

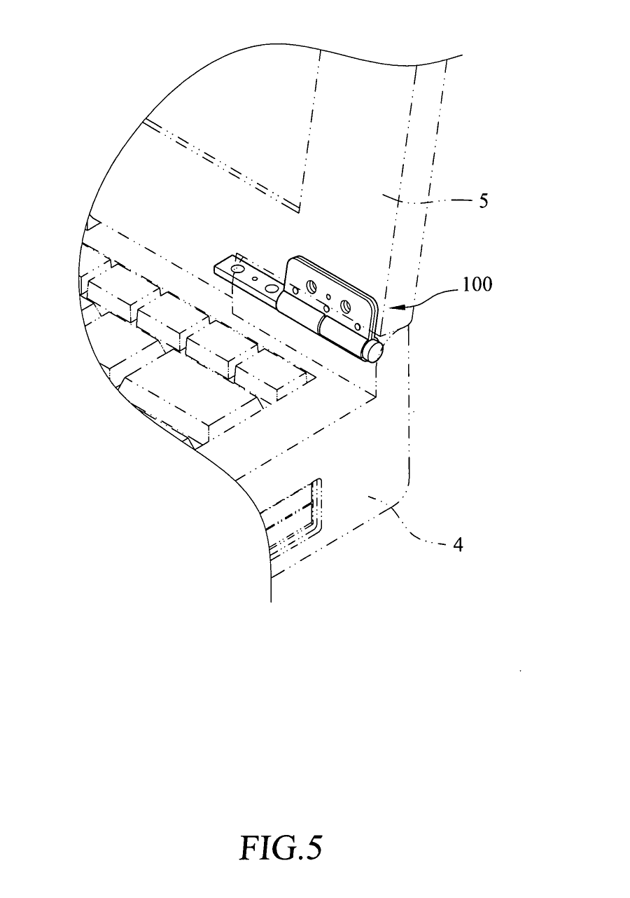

FIG. 5 shows an application of the hinge of the present invention in a notebook computer. The hinge 100 of the present invention is coupled between an enclosure 4 and a liquid crystal display 5 of a notebook computer. In this arrangement, when the liquid crystal display 5 is opened/closed, the hinge 100 of the present invention allows the liquid crystal display 5 to be flipped up from or closed to the enclosure 4 of the notebook computer.

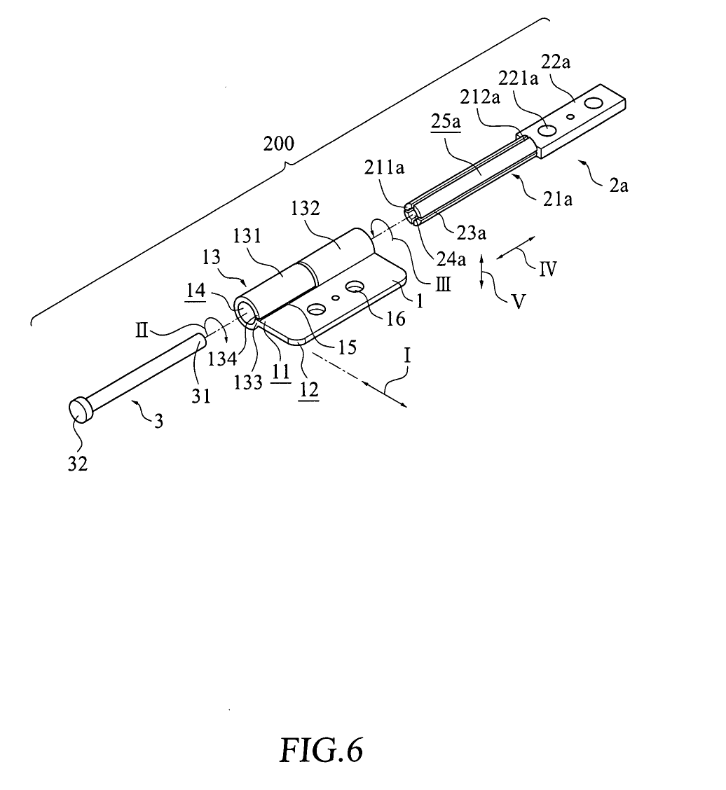

FIG. 6 shows an exploded view of a hinge constructed in accordance with a second embodiment of the present invention, which is designated with reference numeral 200 for distinction. The hinge 200 in accordance with the second embodiment has a structure similar to that of the first embodiment, and thus similar parts of the two embodiments carry the same reference numerals. The difference between the hinge 200 of the second embodiment and the hinge 100 of the first embodiment is as follows. The hinge 200 of the second embodiment comprises a pintle 2a that comprises a stem 21a and an end plate 22a and the stem 21a has a free end 211a and a mounting end 212a mounted to the end plate 22a. A plurality of slits 23a is defined in the stem 21a and extends in an axial direction IV from the free end 211a to the mounting end 212a. The stem 21 further forms a central bore 24a that extends from the free end 211a to the mounting end 212a and communicates the slits 23a.

To assemble the hinge 200 of the second embodiment, the stem 21a of the pintle 2a is inserted into the cylinder 13 with the free end 211a thereof. The plurality of slits 23a formed in the stem 21a allows adjustment of the outside diameter of the stem 21a to ease the insertion operation of the stem 21a into the cylinder 13. The pin 3 is then fit into the central bore 24a of the stem 21a to outward expand the stem 21a in the radial direction V to an increased radial dimension. Thus, an outer circumference 25a of the stem 21a induces a predetermined rotation friction with an inside surface 14 of the cylinder 13 to apply a desired torque to the hinge 200.

The end plate 22a forms a plurality of fastening holes 221a for receiving conventional fasteners (not shown) therethrough to secure the pintle 2 to for example a liquid crystal display of the notebook computer.

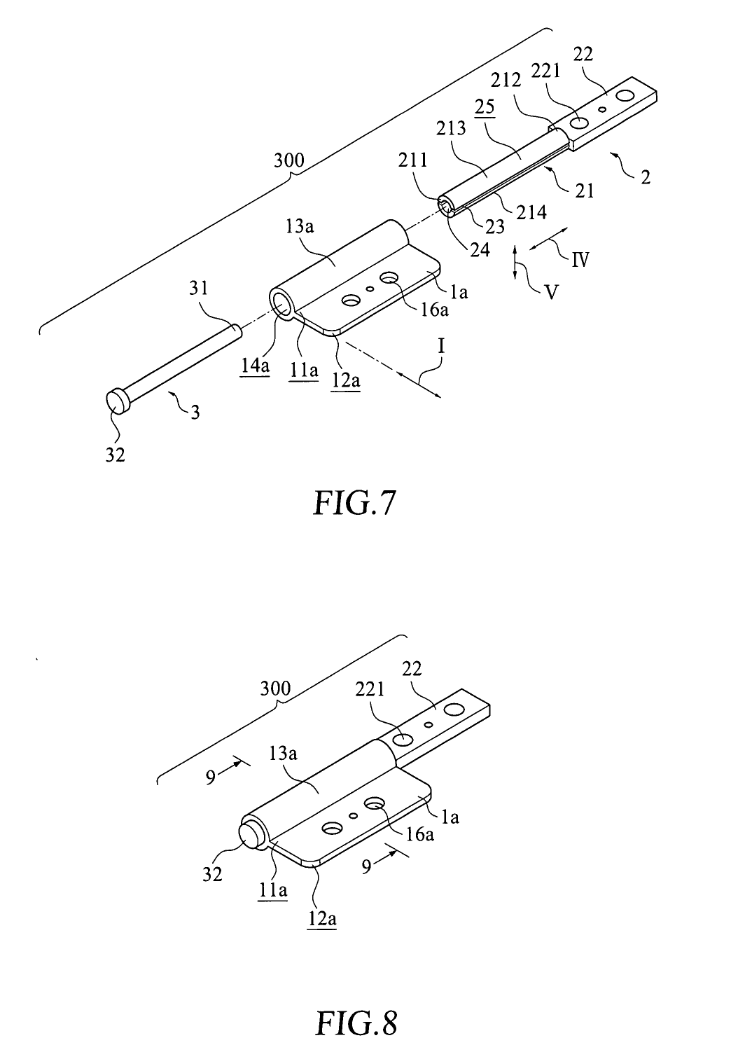

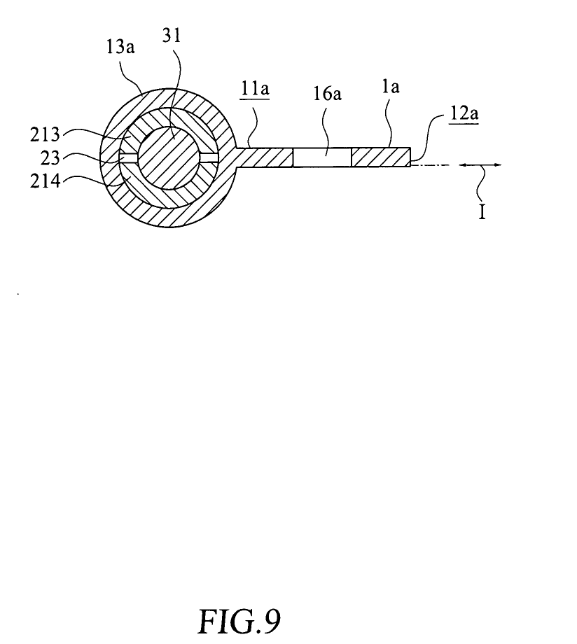

FIG. 7 shows an exploded view of a hinge constructed in accordance with a third embodiment of the present invention, generally designated with reference numeral 300 for distinction. FIG. 8 shows a perspective view of the hinge 300 of the third embodiment in an assembled form. The hinge 300 of the third embodiment has a structure similar to that of the first embodiment, and thus similar parts of the two embodiments carry the same reference numerals. The difference between the hinge 300 of the third embodiment and the hinge 100 of the first embodiment is as follows. The hinge 300 of the third embodiment comprises a bracket 1a having a first edge 11a and an opposite second edge 12a. The first edge 11a forms a cylinder 13a. Also referring to FIG. 9, which shows a cross-sectional view take along line 9-9 of FIG. 8, the cylinder 13a is constructed as a closed circular or ring-like configuration.

The stem 21 of the pintle 2 is inserted into the cylinder 13a with the free end 211 thereof. Once again, the slit 23 of the stem 21 allows for adjustment of the outside diameter of the stem 21 to ease insertion of the stem 21. The pin 3 is then fit into the central bore 24 of the stem 21 to outward expand the stem 21 in the radial direction V to an increased radial dimension. Thus, an outer circumference 25 of the stem 21 induces a predetermined rotation friction with an inside surface 14a of the cylinder 13a to apply a desired torque to the hinge 300.

The bracket 1a forms a plurality of fastening holes 16a for receiving conventional fasteners (not shown) therethrough to secure the hinge 200 to for example an enclosure of a notebook computer.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hinge comprising:
a bracket comprising a plate-like structure extending along a horizontal datum plane and having a first edge and an opposite second edge;
at least one cylinder mounted to the first edge of the bracket;
a pintle comprising a stem and an end plate, the stem having a free end and a mounting end mounted to the end plate, the stem forming at least one slit that extends in a direction from the free end toward the mounting end;
a pin having an insertion end and a distal end;
wherein the stem of the pintle is insertable into the cylinder with the free end thereof and the pin is insertable into the slit of the stem with the insertion end thereof that is positioned to align to the free end of the stem whereby the stem is radially expanded to an increased outside diameter to have an outside circumference of the stem inducing a predetermined rotation friction with an inside surface of the cylinder of the bracket.

2. The hinge as claimed in claim 1, wherein the cylinder has a root end and a non-fixed end, the root end being mounted to the first edge of the bracket, the non-fixed end being extended in a circular path along an angular direction to thereby form a ring-like configuration having a gap.

3. The hinge as claimed in claim 1, wherein the cylinder of the bracket comprises a first-direction cylindrical section and a second-direction cylindrical section closely adjacent to the first-direction cylindrical section, wherein:
the first-direction cylindrical section has a root end and a non-fixed end, the root end being mounted to the first edge of the bracket, the non-fixed end being extended in a circular path along a clockwise angular direction to thereby form an open ring-like configuration having a gap; and
the second-direction cylindrical section has a root end and a non-fixed end, the root end being mounted to the first edge of the bracket, the non-fixed end being extended in a circular path along a counterclockwise angular direction to thereby form an open ring-like configuration having a gap,

4. The hinge as claimed in claim 1, wherein the cylinder has a closed ring-like configuration.

5. The hinge as claimed in claim 1, wherein the slit extends from the free end of the stem to a location close to the mounting end of the stem of the pintle.

6. The hinge as claimed in claim 1, wherein the stem of the pintle forms a central bore extending in a direction from the free end of the stem toward the mounting end of the stem, the central bore being in communication with the slit, whereby when the pin is inserted into and coupled to the stem, the insertion end of the pin is fit into the central bore of the stem.

7. The conductor pattern structure as claimed in claim 1, wherein the pin forms an expanded end.
